(19) United States
(12) Patent Application Publication
(10) Pub. No.: US 2008/0278704 A1
(43) Pub. Date: Nov. 13, 2008

(54) ILLUMINATION SYSTEM FOR A PROJECTION EXPOSURE APPARATUS WITH WAVELENGTHS LESS THAN OR EQUAL TO 193 nm

(75) Inventors: Martin Endres, Koenigsbronn (DE); Jens Ossmann, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/828,512

(22) Filed: Jul. 26, 2007

(30) Foreign Application Priority Data
Aug. 2, 2006 (DE) 10 2006 036 064
Jul. 2, 2007 (EP) 07012914.3

(51) Int. Cl. G03B 27/54

(52) U.S. Cl. 355/67

(57) ABSTRACT

The disclosure relates to illumination systems for projection exposure apparatuses, projection exposure apparatus, and related components, systems and methods. The illumination systems can be configured to be used with wavelengths less than 193 nm.

### CROSS-REFERENCE TO RELATED APPLICATIONS

This applications claims priority under 35 U.S.C. §119 to German Patent Application Serial No. 10 2006 036 064, filed Aug. 2, 2006, and to European Patent Application Serial No. 07012914.3, filed Jul. 2, 2007. These applications are incorporated herein by reference.

### FIELD

The disclosure relates to illumination systems for projection exposure apparatuses, projection exposure apparatus, and related components, systems and methods. The illumination systems can be configured to be used with wavelengths less than or equal to 193 nm.

### BACKGROUND

Illumination systems for microlithography applications with wavelengths λ≦193 nm are known.

### SUMMARY

The present disclosure can provide illumination systems (e.g., configured to work with wavelengths λ≦193 nm) that are of relatively simple construction and/or inexpensive.

In one aspect, the disclosure features an optical system configured so that during use the optical system directs light along an optical path to illuminate a field plane. The optical system includes an optical element that includes a plurality of field raster elements including a first field raster element. The optical system also includes a device. The first field raster element has a first partial area and a second partial area. The optical element is in a second plane in the optical path that is upstream from the field plane. During use, in the second plane the light illuminates the first partial area of the first field raster element but not the second partial area of the first field raster element. The device is configured so that during use the device can adjust the size of the first and second partial areas of the first field raster element to adjust a field illumination of a field in the field plane. The optical system is a projection exposure apparatus illumination system configured to be used with wavelengths of less than 193 nm.

In another aspect the disclosure features an optical system configured so that during use the optical system directs light along an optical path to illuminate a field plane. The optical system includes an optical element that includes a plurality of field raster elements. The optical system also includes a plurality of pupil raster elements. The optical element is in a second plane in the optical path that is upstream from the field plane. During use, in the second plane the light does not completely illuminate at least some of the plurality of field raster elements but not the second partial area of the first field raster element. The field raster elements that are not completely illuminated are arranged in such a way in the second plane that a field illumination is delivered in the field plane with a uniformity error ≦10%. One of the plurality of pupil raster elements is assigned to each of the plurality field raster elements so that during use a light channel is formed between each field raster element and its assigned pupil raster element in such a way that an exit pupil illumination in an exit pupil of the optical system has a scan-integrated ellipticity of 1±0.1. The optical system is a projection exposure apparatus illumination system configured to be used with wavelengths of less than is 193 nm.

In a further aspect, the disclosure features a system that includes the illumination system described in either of the preceding two paragraphs, and a projection objective. The system is a projection exposure apparatus configured so that an object illuminated in the field plane by the illumination system is projected into an image plane of the projection objective.

In an additional aspect, the disclosure features a method that includes providing an optical system that includes an optical element that includes field raster elements. The optical system is configured so that during use the optical system directs light along an optical path to illuminate a field plane and an exit pupil plane. The optical element is in a second plane along the optical path upstream of the field plane. The method also includes using an illumination-adjusting device to adjust an illumination in the second plane so that the uniformity of the field illumination of the field has a uniformity error ≦10. The method further includes assigning to each of the field raster elements a pupil raster element of a second optical element, whereby a light channel is defined. The assignment is made so that the illumination of the exit pupil plane has a telecentricity error of ≦2 mrad, and/or an ellipticity of 1±0.1.

The concept of a uniform illumination in the field plane of an illumination system is used herein with the meaning that the difference ΔSE between the minimum and the maximum of scan-integrated energy, the so-called uniformity error over the field height is below a certain value. The uniformity error ASE expressed as a percentage, is defined by the expression:

$$Δ S E = \frac{S E ( max ) - S E ( min )}{S E ( max ) + S E ( min )} \cdot 100 [ \% ]$$

The term “telecentricity error” as used herein means the deviation of the point of intersection of the central ray in the exit pupil plane from the center of an exit pupil of, e.g., circular shape.

The term “ellipticity” means a relative weight factor characterizing the energy distribution in the exit pupil. If the energy in the exit pupil is distributed uniformly over the angular range, the ellipticity has a value of 1. The term “ellipticity error” refers to the deviation of the ellipticity from the ideal value of a uniform distribution, i.e., from an ellipticity value of 1.

In some embodiments, the illumination systems for wavelengths ≦193 nm disclosed herein can exhibit relatively small errors in uniformity, ellipticity, and/or telecentricity. Additionally or alternatively, in certain embodiments, the illumination systems for wavelengths ≦193 nm disclosed herein can have relatively small light losses (relatively high yield of usable illumination light).

In some embodiments, an illumination system (e.g., configured for use with wavelengths ≦193 nm) includes a first facetted optical component with field raster elements in a plane in which a first illumination is provided. At least a part of the field raster elements in the plane are not completely illuminated and a device is provided for adjusting the illumination of the incompletely illuminated field raster elements. Via this device the uniformity of a second illumination of a field in a field plane can be adjusted. The terminology “not completely illuminated” as used herein means that less than 95% (e.g., less than 90%, less than 85%, less than 80%, less than 75%) of the surface of a raster element are filled with illumination. In an incompletely illuminated field facet, or in an incompletely illuminated field raster element, only a first partial area of the field facet is illuminated.

According to the disclosure, the light is blocked for example by a light barrier, so that a second partial area of the field raster element receives practically no light, i.e. is largely screened off from the light. If a field raster element is for example 50% illuminated, the first partial area, which is illuminated, makes up 50% of the total surface of the field raster element, and the second, non-illuminated and therefore dark portion of the field raster element likewise makes up 50% of the total surface of the field raster element.

In certain embodiments, the disclosure provides illumination systems for projection exposure apparatuses configured for use with wavelengths ≦193 nm (e.g., ≦126 nm, ≦30 nm, from 10 nm to 30 nm), where the light from a light source is directed along a light path into a field plane which contains an optical element with a multitude of field raster elements which is arranged in a plane which, in a light path from the light source to the field plane, is arranged to follow after the light source. Illumination is provided in the plane and at least one field raster element of the multitude of field raster elements in the plane is illuminated only in a first partial area and not illuminated in a second partial area. An adjusting device is provided for adjusting the respective sizes of the first and second partial areas of the field raster element. With the adjusting device a uniformity of a field illumination of a field in the field plane can be adjusted.

In certain embodiments, using an illumination system according to the disclosure, only the illumination of the partially illuminated field facets is changed in order to adjust the uniformity, which can allow for a relatively simple mechanical design. For example aperture stops that are fastened at the border can be used (e.g., so that no mechanical components protrude into the light path where they would cause obscurations). Furthermore, the aperture stop system also makes it possible to admit additional light from the light path.

In certain embodiments, the uniformity error is better than ±5% (e.g., better than ±2%, better than ±0.5%), and/or if the scan-integrated ellipticity as a function of the x-position, i.e. of the field height in a field to be illuminated, lies in the range of 1±0.1 (e.g., 1±0.05, 1±0.02). In some embodiments, additionally or alternatively, an illumination system can have a small telecentricity error which, dependent on the position in the field, i.e. dependent on the field height, does not exceed an error of ±2.5 mrad (e.g., does not exceed ±1.5 mrad, does not exceed ±0.5 mrad). Additionally or alternatively, in some embodiments, more than 70% (e.g., more than 80%, more than 90%) of the energy of the light source which falls into the plane in which the field raster elements are arranged can be received by the field raster elements.

In certain embodiments, the field in the field plane can have a first shape and the field raster elements have a second shape, with the first shape being largely in agreement with the second shape. If the field has the shape of a circular arc, the field raster-elements can likewise be of arcuate shape, such as described, for example, in U.S. Pat. No. 6,195,201.

In some embodiments, if the field raster elements have the shape of the field to be illuminated, the field raster elements can be arranged in columns and rows on a carrier structure of the ficeted optical element. In such embodiments, the rows can be configured such that they are not offset relative to each other, which can help to achieve a high packing density as described in U.S. Pat. No. 6,452,661.

In certain embodiments, if the field raster elements are arranged in columns and rows, several field raster elements can be grouped into blocks.

In certain embodiments, the device for adjusting the illumination includes at least one aperture stop, wherein the aperture stop can be assigned to a field raster element that is incompletely illuminated. As an alternative, it is possible that several field facets are assigned to one aperture stop (e.g., if the field facets and thus their associated aperture stops have very small dimensions).

If the illumination system is used in a scanning projection exposure apparatus, the field can have one uniquely distinguished direction, namely the scanning direction, which is also referred to as y-direction. The one or more aperture stops are in this case configured to be movable substantially perpendicular to the scanning direction. By moving the one or more aperture stops substantially perpendicular to the scanning direction, i.e. in the x-direction, a controlled amount of light, i.e. energy, can be taken out of the field or added to the field dependent on the field height x. This can make it possible to influence the uniformity of the illumination in the field plane dependent on the field height.

As an alternative to aperture stops, the device for adjusting the illumination can also have a multitude of wires serving for the attenuation of light. A light attenuator of this kind is presented for example in EP 1291721. If an adjustment is made via wires, the latter are for example moved in such a way that the shadows of the wires obscure certain areas of the field facets. Further devices for adjusting the illumination are for example devices which allow any kind of optical element that is arranged in the light path from the light source to the field plane to be deformed and/or tilted. Possible elements include a collector or a spectral filter or an additional mirror. As a further possibility, aperture stops can be arranged in the light path from the light source to the field plane after the collector, i.e. on the exit side of the collector. To change the illumination of the partially illuminated field facets it is also possible to move the entire optical element with field facets, i.e., the field facet plate.

With the movable adjustment device such as for example the aperture stops that can be assigned to the individual field facets, it is possible to achieve a uniformity error of the field illumination with a magnitude ΔSE ≦10% (e.g., ≦5%, ≦2%). The remaining uniformity error of for example 2% can be caused in essence by degradation of the coatings during operation, thermal deformations of optical components or exchange of optical components or of the light source.

In some embodiments, the uniformity of the illumination system can always be adjusted via the adjustment device in such a way that a specified uniformity error is not exceeded, even if the illumination in the field plane changes over time because of changes in the illumination system. This can be the case for example if the illumination changes because the light source has changed its position in space and over time. The change of the position or of the radiation intensity of the light source relative to a spatial and/or time frame of reference is also referred to as “jitter” of the light source. In other words, with the design configuration according to the disclosure it is possible to always achieve a specified uniformity error by adjusting the illumination of the partially illuminated areas of one or more field raster elements without making alterations in parts of the system.

It is further possible that a change of the spectral intensity distribution of the light source leads to a change in the illumination. To name one relevant factor in this regard, the reflectivity of an optical component is normally dependent on the wavelength of the irradiated light Consequently, a change of this wavelength leads to a change in reflectivity and thus to a change in the illumination.

Exchanging the light source or an optical element in the illumination light path can likewise lead to a change in the illumination (e.g., a change in the uniformity of the illumination in the field plane). A uniformity error caused by an exchange of a component can likewise be corrected with the device according to the disclosure through a targeted screening off of field facets that are only partially illuminated.

The illumination properties of the illumination system can also change as a result of degradation of the coating during operation or as a result of temperature-related deformations of the optical components. With this type of change in the illumination, the adjustment device according to the disclosure likewise allows the uniformity error to be smoothed out.

In some embodiments, an illumination system, via an adjustment device, the uniformity error can always be kept below a specified uniformity error limit, even when there are changes in the illumination due for example to the exchange of optical components, temperature-related deformation of optical components, or due to changes of the light source relative to a spatial and/or time frame of reference. Thus, the disclosure makes it possible to always keep the uniformity error below a specified limit, for example below a uniformity error of 5% (e.g., below 2%), even as changes occur over time in the illumination.

In some embodiments, there are no movable adjustment devices such as for example aperture stops. Instead, the field raster elements that are not completely illuminated are arranged in such a way in the field plane on a support structure of the first facetted optical element that the field illumination of the field has a certain uniformity error in the range ≦5% (e.g., in the range ≦2%).

In certain embodiments, the first illumination in the plane in which the first facetted optical element can be arranged has an annular shape.

In some embodiments, the illumination system is a double-facetted illumination system with a first and a second facetted optical element, as described for example in U.S. Pat. No. 6,438,199 or U.S. Pat. No. 6,198,793. The second facetted optical element can be arranged after the first facetted optical element in the light path from the light source to the field plane. The second facetted optical element can have a multitude of pupil raster elements. A light channel can be formed between each individual field raster element and a pupil raster element. Since the arrangement of the pupil raster elements can determine the light distribution in the exit pupil, it can be possible to set a so-called pupil illumination in the exit pupil plane by appropriately assigning incompletely illuminated field raster elements for example to specific pupil raster elements that are distributed symmetrically around the center, wherein the pupil illumination in the exit pupil plane of the illumination system has a telecentricity that is better than ±2 mrad (e.g., better than ±1 mrad, better than ±0.5 mrad).

In certain embodiments, the field raster elements are assigned to pupil raster elements in such a way that the pupil illumination in the exit pupil of the illumination system has an ellipticity in the range of 1±0.10 (e.g., 1±0.05, 1±0.025).

The disclosure also provides projection exposure apparatuses including an illumination system as well as a projection objective to project into an image plane an image of an object that is illuminated in the field plane by the illumination system.

The disclosure additionally provides methods to adjust the uniformity, telecentricity and ellipticity of an illumination system with an illumination in a plane in which a first facetted optical element with field raster elements is arranged, and a field in a field plane with a field illumination as well as a pupil illumination in an exit pupil. According to the method, the setting of the illumination in the plane in which the field raster elements are arranged is made in such a way that the uniformity error ΔSE of the field illumination of the field is ≦5% (e.g., ≦2%). Next a pupil raster element of a second optical element is assigned to each field raster element, whereby a light channel is defined, wherein the assignment is made in such a way that in an exit pupil plane a pupil illumination is delivered with a telecentricity error of ±1 mrad (e.g., ±0.5 mrad) and/or an ellipticity in the range of 1±0.1 (e.g., 1±0.05, 1±0.02).

In some embodiments, the light of the light source which reaches the first facetted optical element where a first illumination is provided is received by the field raster elements to more than 70% (e.g., more than 80%, more than 90%) as field raster elements that are incompletely illuminated also receive light.

In certain embodiments, the device for setting the illumination can be a system of aperture stops which are moved in a direction perpendicular to the scanning direction.

In order to control the assignment of field raster elements to pupil raster elements, it is possible to arrange field raster elements on a carrier with a tilt angle that can be varied via actuators. This can allow the assignment of the field raster elements to the pupil raster elements to be adjusted.

In certain embodiments, the projection exposure apparatuses according to the disclosure can be suitable for the production of micro-electronic components, wherein an image of a structured mask is projected onto a light-sensitive coating which is positioned in the image plane of a projection objective. The image of the structured mask is developed, whereby a part of the microelectronic component is obtained.

### BRIEF DESCRIPTION OF THE DRAWINGS

The disclosure is described in the following through examples with references to the drawings, wherein:

FIG. 1 is a schematic representation of the principal a double-facetted illumination system;

FIG. 2a illustrates the light ray pattern of a double-facetted illumination system up to the field plane;

FIG. 2b illustrates the light ray pattern of a double-facetted illumination system up to the exit pupil plane;

FIG. 3 illustrates the principal design concept of an illumination system;

FIG. 4a shows a first facetted optical element with field raster elements;

FIG. 4b represents a schematic view of a first facetted optical element with field raster elements and aperture stops according to the disclosure;

FIG. 4c represents a detailed view of a first facetted optical element with devices for adjusting the illumination;

FIG. 4d illustrates the concept of adjusting the illumination through the example of two field facets;

FIG. 5 shows a facetted optical element with pupil facets;

FIG. 6 shows an illuminated ring field in the field plane of an illumination system;

FIG. 7 illustrates the concept of subdividing an exit pupil;

FIG. 8 shows an example of an exit pupil with sub-pupils;

FIGS. 9a and 9b illustrate the assignment of eight partially illuminated field facts to different pupil facets whereby the exit pupil illumination is obtained;

FIG. 10 illustrates the uniformity profile for an embodiment with 312 channels, wherein 100 field facets are not completely illuminated;

FIGS. 11a and 11b illustrate the 0°/90° ellipticity and the −45°/+45° ellipticity as a function of the field height x before and after the uniformity correction; and

FIGS. 12a and 12b illustrate the telecentricity profile before and after the uniformity correction.

### DETAILED DESCRIPTION

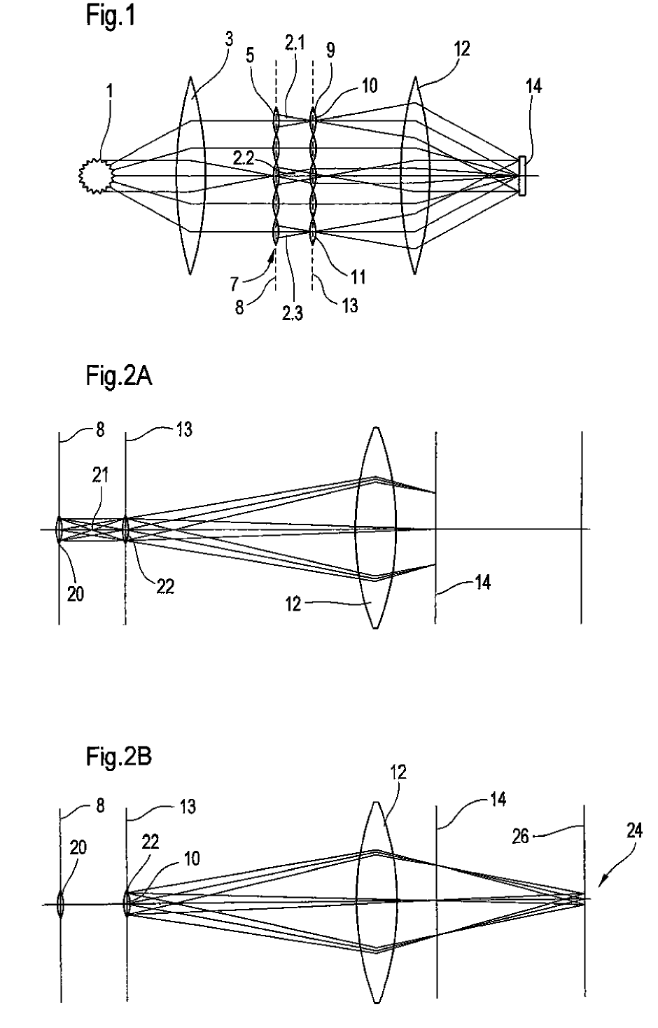

To illustrate the principle, FIG. 1 shows the paths of light rays in a refractive illumination system with two facetted optical elements, also referred to as double-facetted illumination system. In illumination systems for EUV wavelengths in the range from 1 to 20 nm, reflective optical elements are used exclusively, for example reflective mirror facets representing the field facets of the first facetted optical component. The light of a primary light source 1 is collected via a collector 3 and converted into a parallel or convergent light bundle. The field facets, more specifically the field raster elements 5 of the first facetted optical component 7, split the light bundle 2 coming from the light source 1 into a multitude of light bundles 2.1, 2.2 and 2.3 and produce secondary light sources 10 near or at the location of a second facetted optical component 11. The plane in which the first facetted optical component is located is referred to as first plane 8. In the illustrated example the second plane 13, where the second facetted optical component lies and where in the present example also the secondary light sources 10 are formed, is a conjugate plane relative to the exit pupil plane of the illumination system. The field mirror 12 projects images of the secondary light sources 10 into the exit pupil of the illumination system (not shown in this drawing) which coincides with the entry pupil of a projection objective (not shown) which follows downstream in the light path. Images of the field raster elements 5 are projected by the pupil raster elements 9 and the optical element 12 into the field plane 14 of the illumination system. A structured mask, the so-called reticle, can be arranged in the field plane 14 of the illumination system. The following description will explain the purpose of the field raster elements as well as the pupil raster elements shown in FIG. 1 through the example of a first field raster element 20 and a first pupil raster element 22 (referring to FIGS. 2a and 2b) between which a light channel 21 is defined. The first field raster element 20 and the first pupil raster element 22 are again shown as refractive elements, but without thereby implying a limitation to refractive elements. Rather, the illustration with refractive elements is meant to also serve as an example for reflective elements.

An image of the first field raster element 20 is projected into a field plane 14 of the illumination system wherein a field of predetermined geometrical shape is illuminated via the first pupil raster element 22 and the optical element 12. Arranged in the field plane 14 is a reticle, specifically a structured mask. As a general rule, the geometry of the field raster element 20 determines the shape of the illuminated field in the field plane.

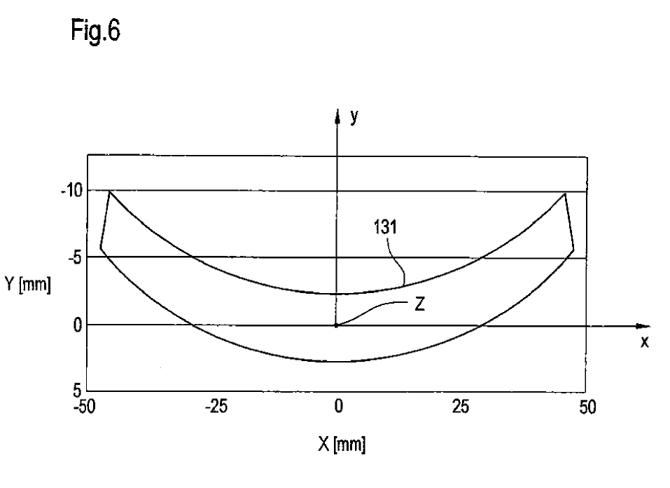

An example of an illuminated field in the field plane with a shape as is typically formed e.g. in a ring field scanner is shown in FIG. 6.

In some embodiments, it may be specified that the field raster element 20 has the shape of the field, i.e. that for example in the case of a ring-shaped field the field raster elements will likewise be ring-shaped. This is shown for example in U.S. Pat. Nos. 6,452,661 or 6,195,201, whose content has been incorporated herein by reference in its entirety.

As an alternative to the aforementioned ring shape, the field raster elements can be of rectangular shape. In order to illuminate the arc-shaped field in the field plane, it is necessary with rectangular field raster elements that the rectangular fields are transformed into arc-shaped fields, for example via a field mirror, as described for example in U.S. Pat. No. 6,198,793.

In some systems with arc-shaped raster elements, a field mirror for the illumination of a ring field in the field plane may not be needed. The field raster element 20 can be configured in such a way that an image of the primary light source 1, a so-called secondary light source 10, is formed near or at the location of the pupil raster element. In the interest of avoiding an excessive heat exposure of the pupil raster elements 9, the latter can be arranged out of focus relative to the secondary light sources.

Due to the defocusing, each of the secondary light sources will extend over a finite area. The area covered can also be due to the shape of the light source.

In some embodiments, the shape of the pupil raster elements is adapted to the shape of the secondary light sources.

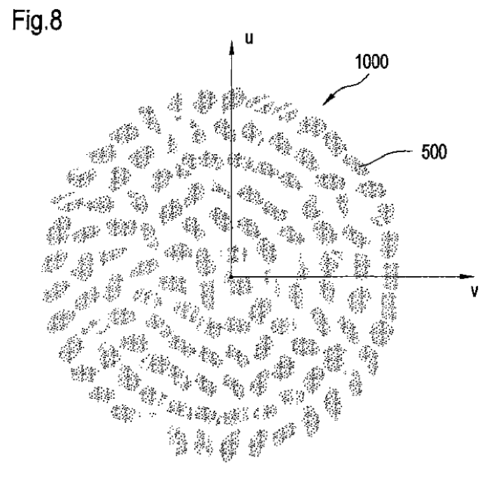

As shown in FIG. 2b, the optical element 12 projects images of the secondary light sources 10 into the exit pupil plane 26 of the illumination system, wherein the exit pupil in the exit pupil plane 26 coincides with the entry pupil of the projection objective. Tertiary light sources, so-called sub-pupils are formed in the exit pupil plane 26 for each secondary light source. This is illustrated in FIG. 8.

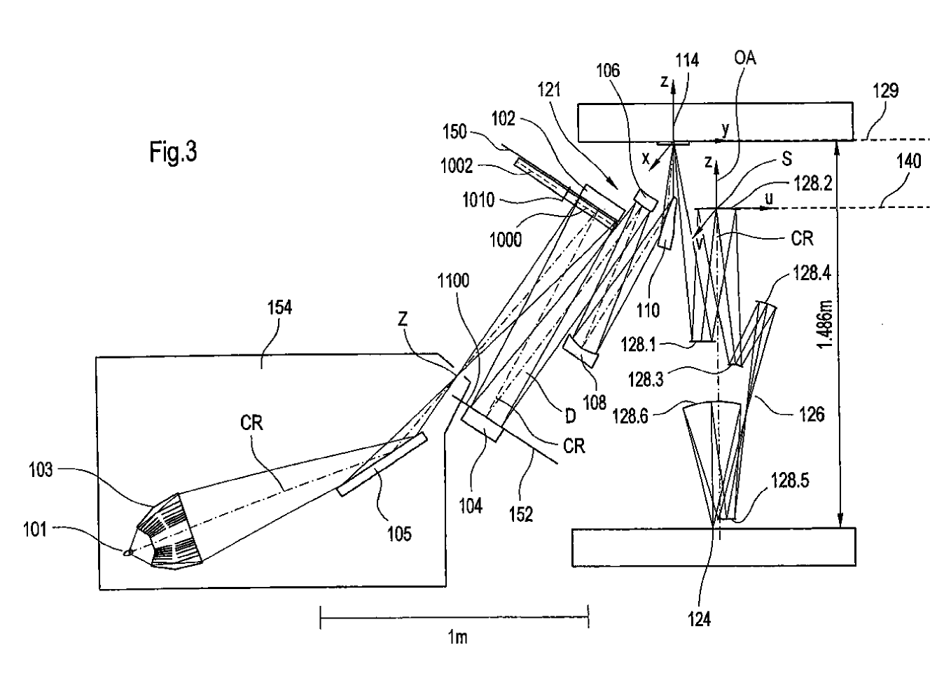

FIG. 3 schematically illustrates a design configuration of a reflective projection exposure apparatus with an illumination system according to the disclosure, as used in EUV lithography. All of the optical components are catoptric elements, i.e. mirrors, an example for which are field facet mirrors. The light bundle of the light source 101 is bundled by a grazing-incidence collector mirror 103, which is in this case configured as a nested collector mirror with a multitude of mirror shells, and after spectral filtering in a spectral grid filter element 105 in conjunction with the formation of an intermediate image Z of the light source, the light bundle is directed to the first facetted optical element 102 with field raster elements. The light source 101, the collector mirror 103, as well as the spectral grid filter 105 together form a so-called source unit 154. The first facetted optical element 102 with field raster elements produces secondary light sources at or near the location of the second facetted optical element 104 with pupil raster elements. The first facetted optical element 102 is arranged in a first plane 150, and the second facetted optical element 104 is arranged in a second plane 152. Because as a rule the light source is a light source that extends over a finite area, the secondary light sources likewise extend over a certain area, meaning that each of the secondary light sources has a predetermined shape. As described above, the individual pupil raster elements can be adapted to the predetermined shape of the secondary light source.

The pupil raster elements serve the purpose that together with the optical elements 121, they project images of the field raster elements into a field plane 129 of the illumination system where a structure-carrying mask 114 can be arranged. In the field plane, a field plane illumination of a field is delivered as shown for example in FIG. 6.

The distance D between the first facetted optical element 102 and the second facetted optical element 104 is indicated in FIG. 3 and is defined along the principal ray (also referred to as chief ray) CR through the central field point Z, which runs from the first optical element 102 to the second optical element 104.

Assigned to each field raster element of the first facetted optical element 102 is a pupil raster element of the second facetted optical element 104, as illustrated in FIGS. 1 to 2b. Between each field raster element and each pupil raster element, there is a light bundle running from the field raster element to the pupil raster element. The individual light bundles that propagate from the field raster element to the pupil raster element are referred to as light channels.

Further illustrated in FIG. 3 is the exit pupil plane 140 of the illumination system, which coincides with the entry pupil plane of the projection objective 126. The exit pupil plane is defined by the point of intersection S where the principal ray CR through the central field point Z of the ring field, which is shown as an example in FIG. 6, crosses the optical axis OA of the projection system 126. A pupil illumination is produced in the exit pupil plane 140.

An example of an exit pupil for an illumination system of the kind shown in FIG. 3, is illustrated with a pupil illumination in FIG. 8.

The projection system or more specifically the projection objective 126 in the illustrated embodiment has the six mirrors 128.1, 128.2, 128.3, 128.4, 128.5, and 128.6. An image of the structured mask is projected via the projection objective into the image plane 124, where a light-sensitive object is arranged.

FIG. 3 shows the local x-y-z coordinate system in the field plane 129 and the local u-v-z coordinate system in the exit pupil plane 140.

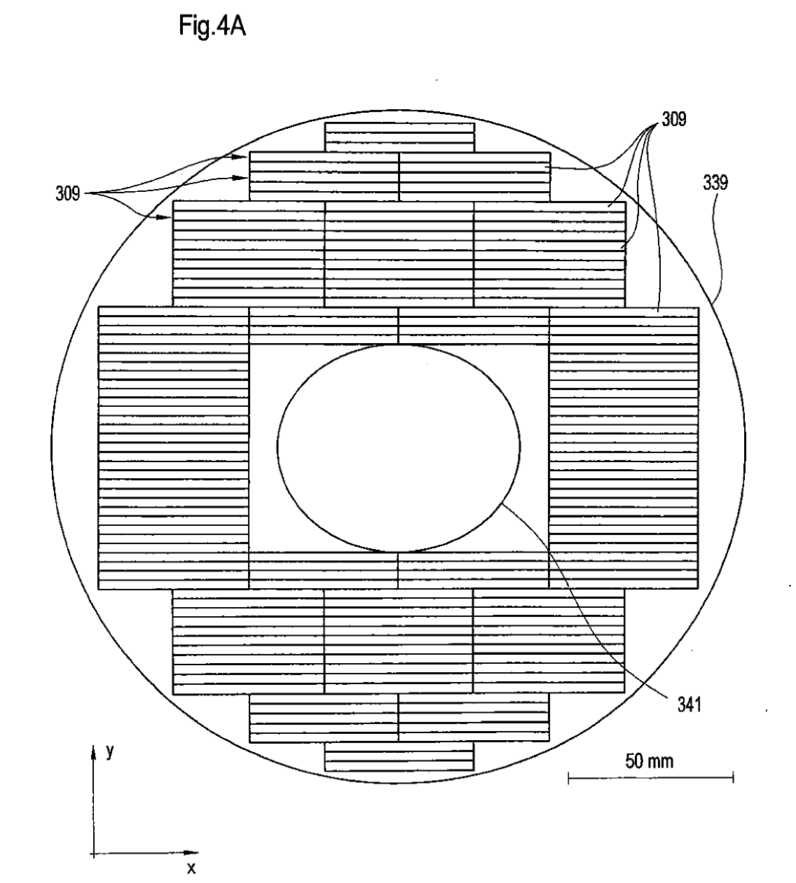

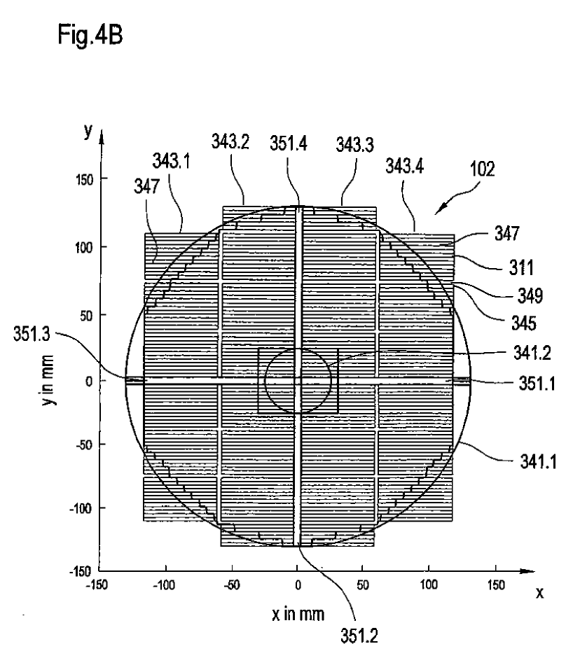

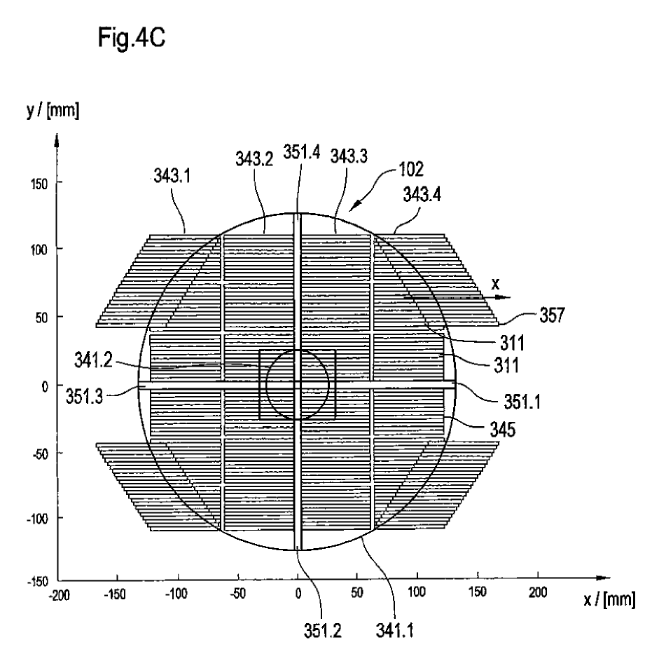

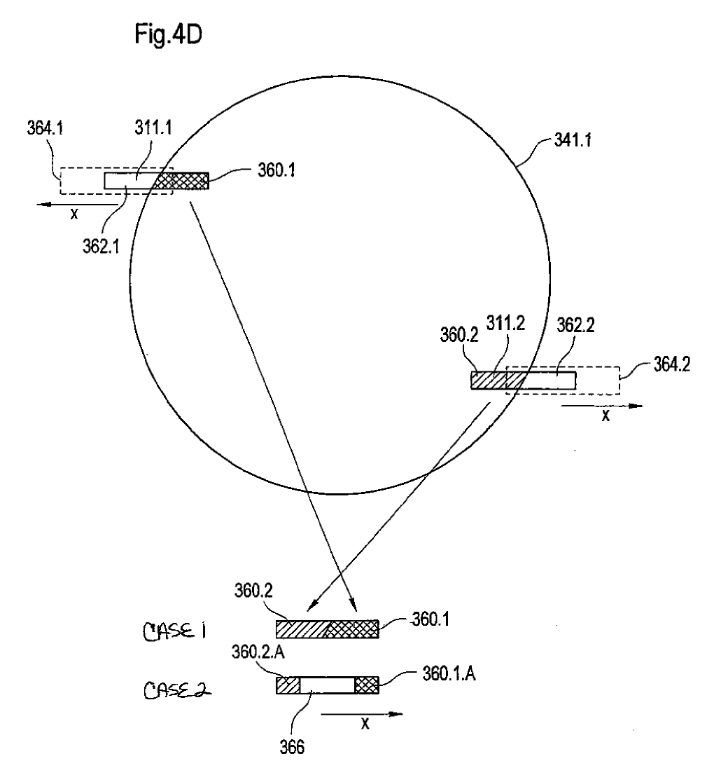

FIG. 4a illustrates a two-dimensional arrangement of field raster elements according to the state of the art, wherein with the circle-shaped illumination less than 70% of the incident light coming from the light source is received and used for the illumination of the field in the field plane. The individual reflective field facets 309 are arranged on a first facetted optical element a so-called field honeycomb plate, which is identified in FIG. 3 with the reference symbol 102. FIG. 4a illustrates a possible arrangement of 178 field raster elements 309 on a field honeycomb plate according to the state of the art. The circle 339 indicates the outer illumination border of a circle-shaped illumination of the first optical element with field raster elements 309. The field raster elements 309, which are substantially rectangular, have for example a length X_{FRE}=43.0 mm and a width Y_{FRE}=4.00 mm. All field raster elements 309 are arranged inside the circle 339 and are therefore completely illuminated. As can be seen in FIG. 4a, a large proportion of the light falling on the field facet mirror is not being utilized. The circle 341 indicates the inner illumination border which is caused for example by a central light barrier of a nested collector.

FIGS. 4b to 4d illustrate arrangements of first facetted optical elements in accordance with the disclosure.

FIG. 4b shows an arrangement of 312 field facets in total on a first facetted optical element which is identified in FIG. 3 by the reference numeral 102. The individual field facets are identified by the reference symbol 311. The field honeycombs of the individual raster elements 311 are fastened to a support structure (not shown in the drawing) of the first facetted element. As can be seen in FIG. 4b, the illumination of the plane in which the first facetted optical element is arranged is an annular illumination with an outer illumination border 341.1 and an inner illumination border 341.2. Furthermore, the raster elements are subdivided into a total of four columns 343.1, 343.2, 343.3, 343.4 and into individual rows 345. The raster elements 311 of individual rows are aligned directly below each other in the columns, in contrast to the arrangement shown in FIG. 4a where the field facets in different rows are offset against each other. The individual facets are further grouped together in blocks 347 which are arranged below each other. The blocks and columns are separated from each other by free spaces 349. Further shown in FIG. 4b are the shadows 351.1, 351.2, 351.3, 351.4 of the spokes which hold the individual shells of the grazing-incidence collector 103 which can be seen in FIG. 3. As is evident from FIG. 4b, many of the field facets are only partially illuminated. Also indicated in FIG. 4b is the coordinate system with axes in the x- and y-directions. As shown in FIG. 4b, the dimensions of the field facets in the scanning direction of the projection exposure apparatus which coincides with the y-direction are significantly smaller than in the x-direction which runs perpendicular to the scanning direction.

In some embodiments, an advantage can be that the field facets can be arranged in blocks, which can simplify the assembly process. The staggered arrangement of the field facets as practiced in the prior art according to FIG. 4a was necessary in order to fill the round, circle-shaped illuminated area of the field facet mirror as much as possible with completely illuminated field facets. With the present concept where partially illuminated facets also contribute to the illuminated area, this offset can be avoided.

FIG. 4c shows a first facetted optical component 102 of a similar design as shown in FIG. 4b. Analogous components carry the sane reference symbols. The individual raster elements 311 in FIG. 4c are again arranged in a total of four columns 343.1, 343.2, 343.3, 343.4 and a large number of rows 345. Furthermore, the individual rows can be spaced apart from each other in such a way that no field facets are arranged in the areas that are shadowed by the spokes of the gazing-incidence collector.

The illuminated area further has an outer border 341.1 as well as an inner border 341.2.

Also indicated in FIG. 4c are aperture stops 357 for the field raster elements that are not completely illuminated. Each of the aperture stops 357 is assigned to a field raster element 311. The individual aperture stop 357 which is assigned to a field raster element is movable in the x-direction as indicated by the arrow X. As a result, one obtains an illuminated area in the field plane which can be variably adjusted. This is shown in a more detailed representation in FIG. 4d.

FIG. 4d illustrates how the illuminated area can be adjusted in the x-direction. To visualize the concept, two field raster elements that are only partially illuminated, specifically field facets 311.1 and 311.2 at the outer border 341.1 of an illuminated area, are represented. The partially illuminated field raster elements comprise illuminated portions 360.1 and 360.2, respectively, for the field raster elements 311.1 and 311.2, as well as non-illuminated portions 362.1 and 362.2, respectively, for the field raster elements 311.1 and 311.2. When the partially illuminated field raster elements 311.1, 311.2 are projected into the field plane, the illuminated portions 360.1 and 360.2 superimpose themselves on each other and complement each other to make up a fully illuminated field as illustrated in Case 1 in FIG. 4d. The aperture stops 364.2 and 364.1 allow the size of the illuminated areas of the field facets 311.1 and 311.2 to be adjusted. If the aperture stops 364.1 and 364.2 are set to the positions indicated with broken lines in FIG. 4d, the superposition of the field facets on each other in the field plane produces the illumination shown in Case 2 in FIG. 4d. As illustrated only the portions 360.1.A and 360.2.A of the field are illuminated. The portion 366 is not illuminated. As FIG. 4d clearly demonstrates, by moving the aperture stops 364.1 and 364.2 in the x-direction, it is possible depending on the field height to remove energy from the illuminated field or to add energy into the field.

This adjustment capability is based on the condition that the uniformity of the illumination, i.e. the variation of the uniformity can be influenced dependent on the field height.

Given the capability to influence the uniformity dependent on the field height with the adjustment device shown in FIGS. 4a and 4d in the form of aperture stops, it becomes possible in the case of sudden changes of the illumination and thus of the uniformity in the field plane, for example due to changes of the light source with regard to its spatial position as well as over time with regard to its radiation intensity, or when optical components are exchanged such as for example a collector or a light source, to adjust the uniformity of the illumination via the aperture stops 364.2 and 364.1 in such a way that the uniformity error lies below a given specific value. The field illumination can thereby be influenced in such a way as to achieve a uniformity error of ΔSE≦10% (e.g., ≦5%, ≦10%). The adjustability thus provides a kind of regulating system for the uniformity of the illumination in the field plane, wherein one adjusts the uniformity for example via the aperture stops of the adjustment device in such a way that the uniformity error is kept below a given uniformity error limit.

As an example, the uniformity and thus the uniformity error can change after an exchange of the light source. With the help of the aperture stops 364.1, 364.2 it is now possible to adjust the illuminated areas of the partially illuminated field facets and to thereby achieve a specified value for the uniformity error.

A readjustment during operation would also be possible. In order to do this, a sensor is moved, for example swiveled, into the field plane or into the image plane of the projection objective after a certain number of exposures and the illumination in this plane is measured. Based on this measurement, it is possible to determine the uniformity error and to make an appropriate adjustment for the correction. This makes it possible for example in the case of degradations of the coatings, e.g. on the collector or on the mirrors, or also in case of changes in the light source, to readjust the uniformity in such a way that a given uniformity error is not exceeded. If the sensor is moved into the image plane, i.e. into the wafer plane, the determination of the uniformity error of the projection objective can be included in the measurement.

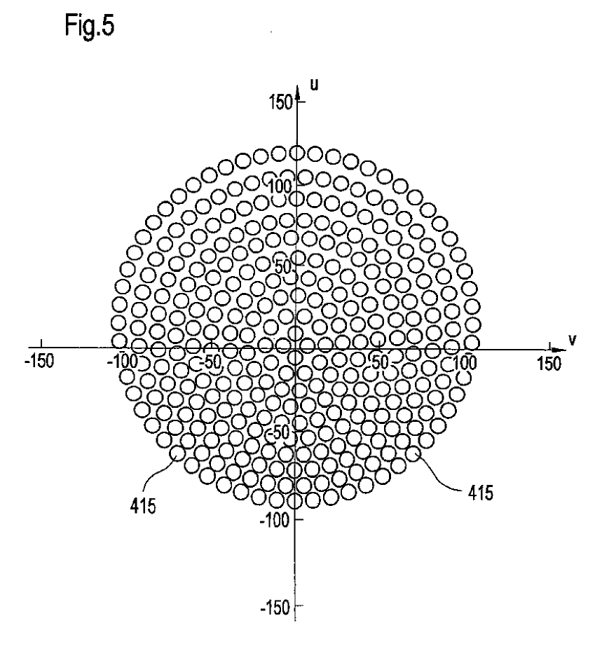

FIG. 5 represents a first arrangement of pupil raster elements 415 on the second facetted optical element which is identified in FIG. 3 by the reference symbol 104. Also indicated is a u-v-z coordinate system. The shape of the pupil raster elements 415 can conform to the shape of the secondary light sources in the plane where the second optical element with pupil raster elements is arranged.

FIG. 6 shows a ring-shaped field of the kind which is formed in the field plane 129 of the illumination system for a ring field scanner according to FIG. 3.

In contrast to the schematically illustrated rectangular field in FIG. 4d, the field 131 is ring-shaped. FIG. 6 shows an x-y coordinate system as well as the central field point z of the field 131. The y-direction indicates the so-called scanning direction in the case where the illumination system is used in a scanning microlithography projection system which is configured as a ring field scanner, while the x-direction indicates the direction perpendicular to the scanning direction. Scan-integrated quantities, meaning quantities that are integrated along the y-axis, can be determined dependent on their respective x-position which is also referred to as field height. Many quantities characterizing an illumination are field-dependent quantities. One such field-dependent quantity is for example the so-called scanning energy (SE) whose magnitude is found to be different depending on the field height x, meaning that the scanning energy is a function of the field height. With general validity, the scanning energy is expressed as

SE(x)=∫E(x,y)dy,

wherein E stands for the intensity distribution as a function of x and y in the x-y field plane. In order to achieve uniformity, i.e. an even distribution, of the illumination and other characteristic quantities of the illumination system such as the ellipticity and the telecentricity which likewise depend on the field height x, it is advantageous if these quantities have substantially constant values over the entire field height x with only minor deviations.

The uniformity of the scanning energy in the field plane is measured in terms of the variation of the scanning energy over the field height. Thus, the uniformity is described by the following relationship for the uniformity error in percent:

$$Δ S E = \frac{S {E}_{max} - S {E}_{min}}{S {E}_{max} + S {E}_{min}} \times 100 [ \% ] ,$$

wherein ΔSE stands for the uniformity error which is expressed as the variation of the scanning energy in %.
SE_{Max}: maximum value of the scanning energy
SE_{Min}: minimum value of the scanning energy

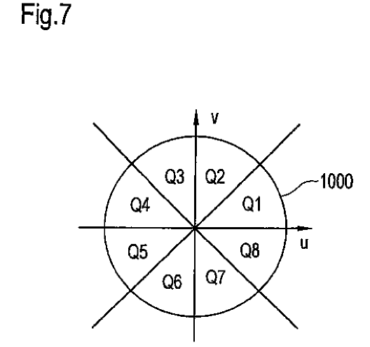

The term “ellipticity” as used herein means a relative weight factor characterizing the energy distribution in the exit pupil, more specifically in the exit pupil plane. If a coordinate system with the directions u, v, z is defined in the exit pupil plane 140, as shown in FIG. 7, the energy in the exit pupil 1000 distributes itself over the angular range of the coordinate axes u, v. The pupil in FIG. 7 is subdivided into the angular ranges Q1, Q2, Q3, Q4, Q5, Q6, Q7, Q8. The energy contained in each angular range is obtained by an integration over the respective angular range. For example, I1 stands for the energy contained in the angular range Q1. Accordingly, I1 is represented by the expression:

$$I 1 = {\sum }_{Q 1} E ( u , v ) d u d v ,$$

wherein E(u,v) stands for the intensity distribution in the pupil.

The −45°/45° ellipticity is defined as:

$${E}_{- 45 ° \text{/} 45 °} = \frac{I 1 + I 2 + I 5 + I 6}{I 3 + I 4 + I 7 + I 8} ,$$

and the 0°/90° ellipticity is defined as:

$${E}_{0 ° \text{/} 90 °} = \frac{I 1 + I 8 + I 4 + I 5}{I 2 + I 3 + I 6 + I 7} ,$$

In the foregoing equations, I1, I2, I3, I4, I5, I6, I7, I8 in accordance with the definition above represent the respective energy contents in the angular ranges Q1, Q2, Q3, Q4, Q5, Q6, Q7, Q8 of the exit pupil shown in FIG. 7.

Since a different exit pupil is associated with each field point of the illuminated field in the field plane, the pupil and thus the ellipticity depends on the position within the field. A ring-shaped field of the kind used in microlithography is shown in FIG. 6. The field is described by an x-y-z coordinate system in the field plane 129. As the pupil is dependent on the field point, it depends on the x-y position in the field, wherein the y-direction represents the scanning direction.

Furthermore a mean ray of a light bundle is defined for each field point of the illuminated field. The mean ray represents the mean direction of the radiated energy in a light bundle originating from a field point.

The deviation of the mean ray from the principal ray (also referred to as chief ray) CR is represented by the so-called telecentricity error. The telecentricity error conforms to the equations:

$$\overline{s} ( x , y ) = \frac{1}{N} \int d u d v ( \begin{matrix}u \\ v\end{matrix} ) E ( u , v , x , y ) , N = \int d u d v E ( u , v , x , y ) ,$$

wherein E(u, v, x, y) represents the energy distribution as a function of the field coordinates x, y in the field plane 129 and the pupil coordinates u, v in the exit pupil plane 140.

As a general rule, an exit pupil in the exit pupil plane 140 of the illumination system according to FIG. 3 is assigned to each field point of a field in the field plane 129. In the exit pupil that is assigned to a given field point, a multitude of tertiary light sources are formed which are also referred to as sub-pupils.

As an example, FIG. 8 shows a scan-integrated pupil for a field height of x=−52 mm of an arc-shaped field of the type shown in FIG. 6.

The scan-integrated pupil results from the integration over the energy distribution E(u, v, x, y) along the scanning path, i.e. along the y-direction. Thus, the scan-integrated pupil is described by the expression.

$$E ( u , v , x ) = \int d y E ( u , v , x , y )$$

By integration over the coordinates u, v of the scan-integrated pupil, one obtains the intensities I1, I2, I3, I4, I5, I6, I7, I8 in accordance with the definition given above, and thus the −45°/45° ellipticity or the 0°/90° ellipticity as a function of the field height x, e.g. for x=−52 mm.

As is evident from FIG. 8, the exit pupil has individual sub-pupils in the exit pupil plane, i.e. tertiary light sources 500. As can further be seen in FIG. 8, the individual sub-pupils 500 contain different amounts of energy and have a detail structure that goes back for example to the collector shells or collector spokes of a collector that may, e.g., have a nested configuration, for example the nested collector 103 shown in FIG. 3. The different intensity values of the sub-pupils 500 are a consequence of the incomplete illumination of individual field raster elements or field facets of the first facetted optical element 102. As has been described before, some individual field raster elements are not completely illuminated, while others are completely illuminated. The energy difference between the incompletely and completely illuminated field raster elements has the effect that the ellipticity, for example the −45°/45° ellipticity or the 0°/90° ellipticity, in the exit pupil as well as the telecentricity as a function of the field height, i.e. along the x-coordinate, are strongly variable unless measures are taken to ensure as much as possible a uniform ellipticity over the field height, i.e. along the x-coordinate, as well as telecentricity.

The most uniform ellipticity possible in the exit pupil as a function of the field height or the best possible telecentricity can be achieved by making certain specific assignments of field facets or field raster elements to pupil facets or pupil raster elements.

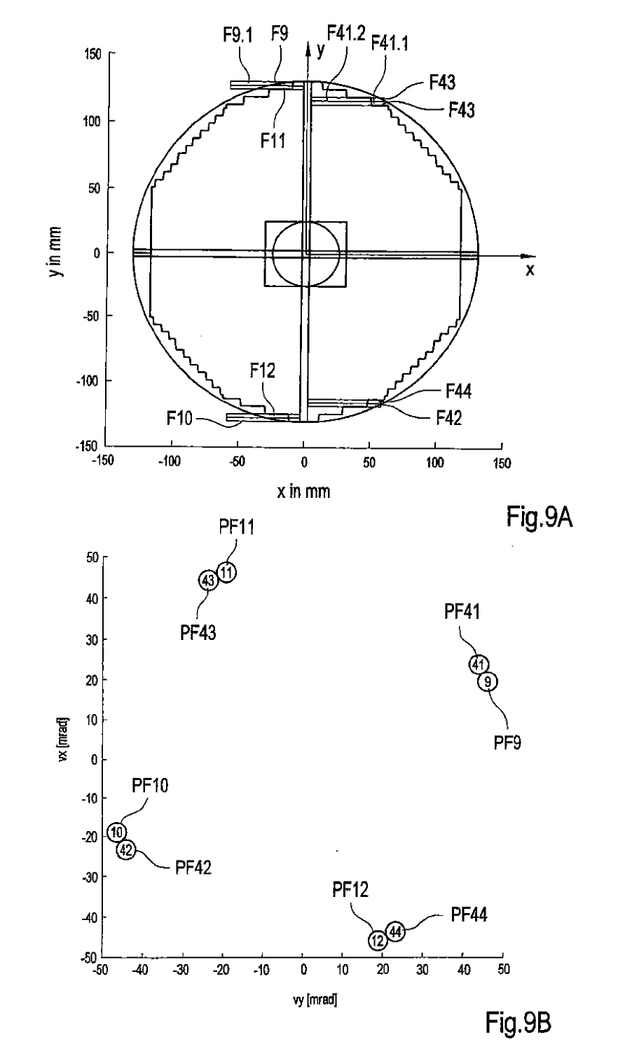

An assignment rule which ensures this is illustrated in FIGS. 9a and 9b for an example of a total of eight field- and pupil facets. FIG. 9a shows the field facets F9, F10, F11, F12 as well as F41, F42, F43 and F44, while FIG. 9b shows the associated pupil facets which lead to the illumination in the exit pupil.

As is evident from FIGS. 9a and 9b, the telecentricity error over the entire field is minimized if field facets in mutually opposite positions, for example the field facets F9 and F10 in FIG. 9a are assigned to point-symmetric sub-pupils in the exit pupil. This is also true for the facets F11 and F12 which lie opposite each other. FIG. 9a shows a facetted optical element with field facets, and FIG. 9b shows the associated facetted optical element with pupil facets PF9, PF10, PF11, PF12, PF41, PF42, PF43, and PF44. The position of the pupil facets, in turn, determines the position of the sub-pupils in the exit pupil. This means that the assignment of field facets to the pupil facets can be made in such a way that field facets in mirror-symmetric positions relative to the x-axis, for example F9 and F10, can be assigned to those pupil facets whose images lie at point-symmetric locations in the exit pupil (PF9 and PR10). As a rule, this is advantageous for the reason that field facets that are arranged mirror-symmetrically relative to the x-axis usually have largely identical intensity profiles.

In order to keep ellipticity errors small, two pairs of adjacent facet mirrors such as the field facets F9, F11 and F10, F12 can be assigned to pupil facet mirrors PF9, PF11 and PF10, PF12 that are offset by 90°. Consequently, field facets with similar intensity profiles lie in octants of the pupil that are offset by 90°.

In the ideal case where I1(x)=I3(x)=I5(x)=I7(x), one obtains

$${E}_{- 45 ° \text{/} 45 °} ( x ) = \frac{I 1 ( x ) + I 5 ( x )}{I 3 ( x ) + I 7 ( x )} = 1.$$

The ellipticity of these four channels is therefore constant over the field and equals 1.

Facets that complement each other in their illumination, for example the facets F9, F41, are assigned to pupil facets PF9, PF41 that meet the condition that the sub-pupils associated with the field facets PF9,k PF41 lie adjacent to each other in the exit pupil.

An arrangement of this kind has the advantage that a uniform illumination is achieved over the exit pupil. The fact that the field facets R9 and F41 complement each other means that the portion F9.1 which is in darkness in the field facet F9 is complemented by the illuminated portion F41.2 of the field facet 41. The dark portion F9.1 has the effect that in the field area that is assigned to F9.1 the associated sub-pupil is dark. Accordingly, the sub-pupil assigned to the pupil facet PF41 is fully illuminated in this field area. If the pupil facets PF9 and PF41 lie adjacent to each other, the effect of a change or transition from illuminated to dark are minimized over the field.

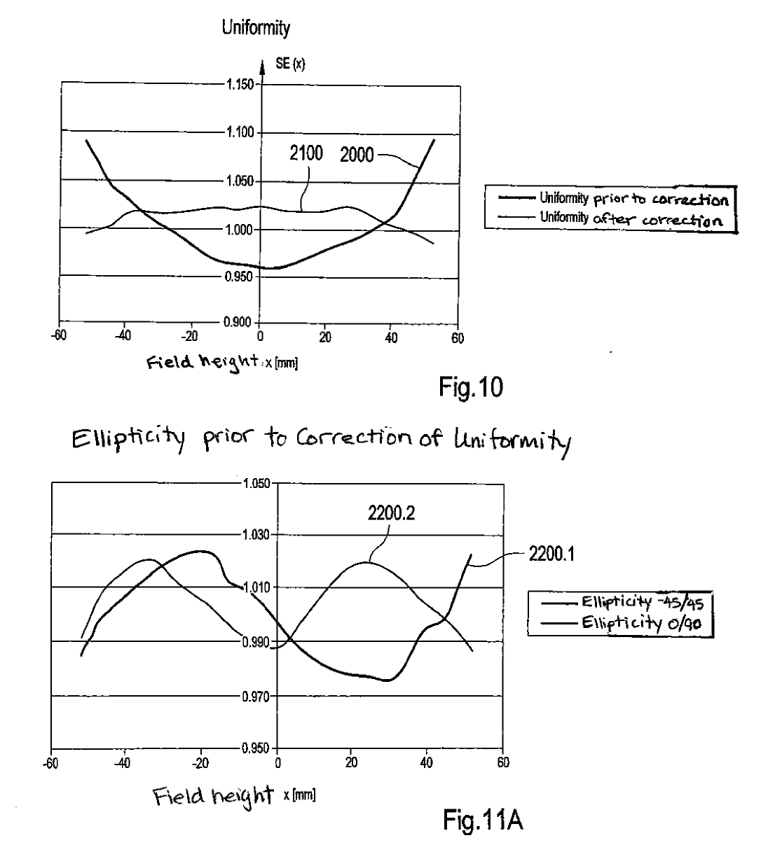

Via the individual aperture stops for the control of the illumination of the individual field facets, it is possible to influence the uniformity of the illumination in the field plane of the illumination system. The uniformity of the illumination can be adjusted for example in such a way that ΔSE(x)≦2%. The result of the uniformity adjustment via aperture stops is illustrated in FIG. 10. While the uniformity error in the absence of a correction has a value of ΔSE ≧10%, the value with the correction is ΔSE ≦5%. The largest value SE_{Max} of the san-integrated energy SE(x) after the correction is about 1.02 and the smallest value SE(x)_{Min} is about 1.0, so that ΔSE≈2% after the field illumination has been corrected via the aperture stops.

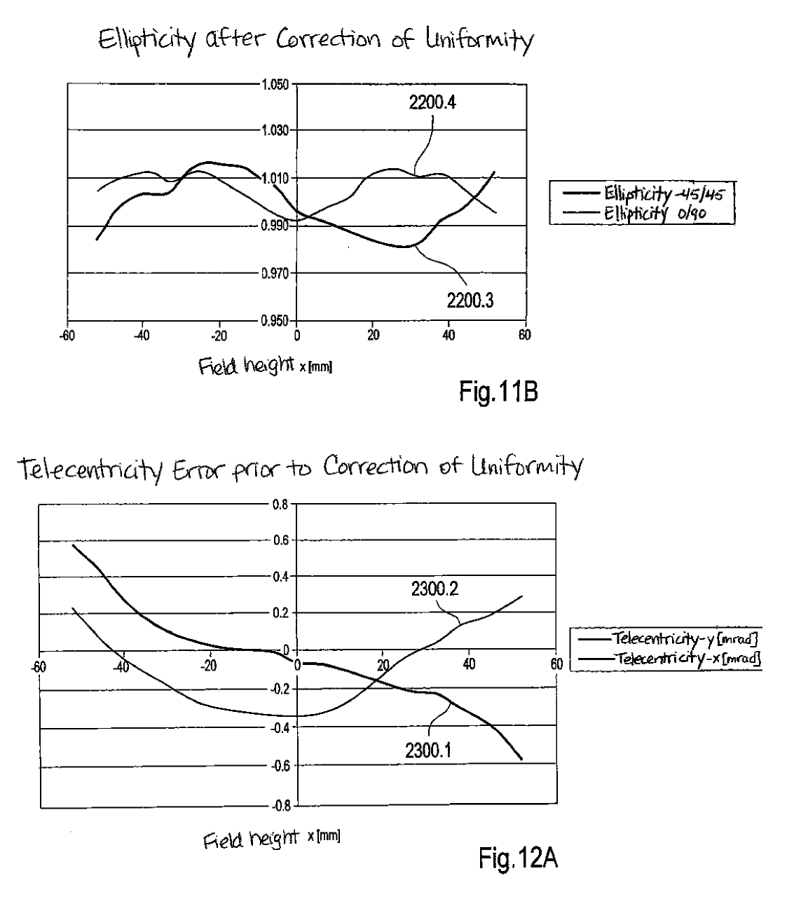

The effect that the adjustment of the uniformity via the aperture stops as described has on the profile of the ellipticity as a function of the field height, i.e. of the x-coordinate, is shown in FIGS. 11a and 11b for the −45°/45° ellipticity or the 0°/90° ellipticity. FIG. 11a shows the −45°/45° ellipticity 2200.1 or the 0°/90° ellipticity 2200.2 for an illumination system according to FIG. 3 with a channel assignment of the field facets to the pupil facets as described above. Dependent on the field height, the −45°/45° ellipticity varies between 0.97 and 1.03, and the 0°/90° ellipticity also varies between 0.97 and 1.03. FIG. 11b shows the profile of the −45°/45° ellipticity 2200.3 or the profile of the 0°/90°ellipticity 2200.4 after the uniformity of the field as shown in FIG. 10 has been corrected. As can be seen in FIG. 11b, in the correction of the uniformity the −45°/45° ellipticity and the 0°/90° ellipticity have only been changed within the permitted error range. The −45°/45° ellipticity varies between 0.990 and 1.01, and the 0°/90° ellipticity varies between 0.99 and 1.02 dependent on the field height.

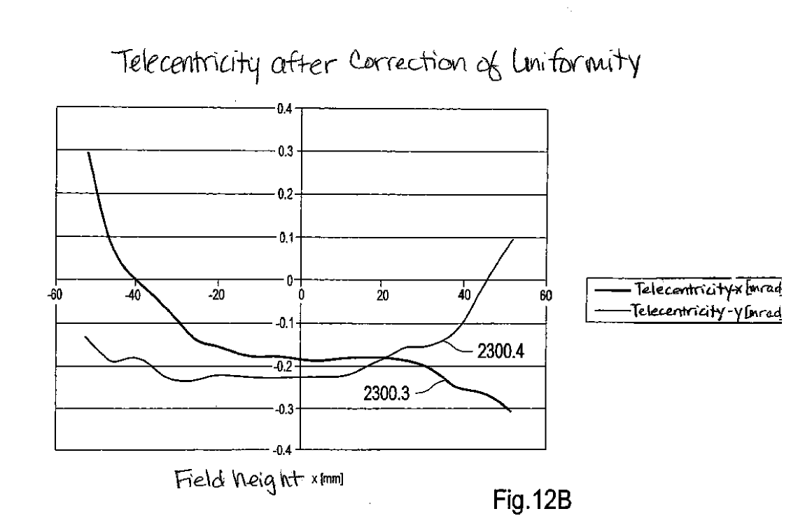

FIGS. 12a and 12b illustrate the telecentricity error of the system in the x- and y-direction dependent on the field height x for a system according to FIG. 3 with the assignment rule stated above for exit pupils at different field heights x.

The telecentricity error in the x-direction as well as in the y-direction amounts to less than 1 mrad. The profile in the x-direction prior to the correction of the uniformity is referenced in FIG. 12a as 2300.1, while the profile in the y-direction is referenced as 2300.2. FIG. 12b shows the telecentricity error after the correction of the uniformity. As can be seen in FIG. 12b, the telecentricity error over the field amounts to less than ±0.2 mrad in the x-direction as well as in the y-direction.

Other embodiments are in the claims.

1. An optical system configured so that during use the optical system directs light along an optical path to illuminate a field plane, the optical system comprising:
an optical element comprising a plurality of field raster elements including a first field raster element; and
a device,
wherein:
the first field raster element has a first partial area and a second partial area,
the optical element is in a second plane in the optical path that is upstream from the field plane,
during use, in the second plane the light illuminates the first partial area of the first field raster element but not the second partial area of the first field raster element,
the device is configured so that during use the device can adjust the size of the first and second partial areas of the first field raster element to adjust a field illumination of a field in the field plane, and
the optical system is a projection exposure apparatus illumination system configured to be used with wavelengths of less than 193 nm.

2. An optical system according to claim 1, wherein more than 70% of the illumination in the second plane is received by the plurality of field raster elements that are arranged in the second plane.

3. An optical system according to claim 1, wherein the field illumination has a uniformity error of ≦10%.

4. An optical system according to claim 1, wherein the field has a first shape, the plurality of field raster elements have a second shape, and the first shape is substantially the same as the second shape.

5. An optical system according to claim 4, wherein the plurality of field raster elements are of an arcuate shape.

6. An optical system according to claim 1, wherein the plurality of field raster elements are arranged in columns and rows, and the rows are not offset relative to each other.

7. An optical system according to claim 1, wherein the plurality of field raster elements are arranged in columns and rows, and multiples of the plurality of field raster elements are grouped together in blocks.

8. An optical system according to claim 1, wherein the device comprises at least one aperture stop.

9. An optical system according to claim 8, wherein the aperture stop is configured to be movable in the second plane.

10. An optical system according to claim 9, wherein a scanning direction is defined in the second plane, and the aperture stop is configured to be movable substantially perpendicular to the scanning direction.

11. An optical system according to one claim 8, wherein the aperture stop is assigned to one or more of the plurality of field raster elements.

12. An optical system according to claim 1, wherein the device comprises at least one member selected from the group consisting of:
devices configured to deform and/or tilt the optical element,
devices configured to move the optical element, and
devices in which at least one aperture stop assigned to a field raster element can be repositioned.

13. An optical system configured so that during use the optical system directs light along an optical path to illuminate a field plane, the optical system comprising:
an optical element comprising a plurality of field raster elements; and
a plurality of pupil raster elements,
wherein:
the optical element is in a second plane in the optical path that is upstream from the field plane,
during use, in the second plane the light does not completely illuminate at least some of the plurality of field raster elements but not the second partial area of the first field raster element,
the field raster elements that are not completely illuminated are arranged in such a way in the second plane that a field illumination is delivered in the field plane with a uniformity error ≦10%,
one of the plurality of pupil raster elements is assigned to each of the plurality field raster elements so that during use a light channel is formed between each field raster element and its assigned pupil raster element in such a way that an exit pupil illumination in an exit pupil of the optical system has a scan-integrated ellipticity of 1±0.1, and
the optical system is a projection exposure apparatus illumination system configured to be used with wavelengths of less than 193 nm.

14. An optical system according to claim 13, wherein the field has a first shape, the plurality of field raster elements have a second shape, and the first shape is largely in agreement with the second shape.

15. An optical system according to claim 14, wherein the plurality of field raster elements have an arcuate shape.

16. An optical system according to claim 13, wherein the plurality of field raster elements are arranged in columns and rows and wherein the rows are offset relative to each other.

17. An optical system according to claim 13, wherein the plurality of field raster elements are arranged in columns and rows and multiples of the plurality of field raster elements are grouped together in blocks.

18. An optical system according to claim 1, wherein the illuminated area in the second plane has the shape of a circle or a ring.

19. An optical system according to claim 1, further comprising a second optical element comprising a second plurality of pupil raster elements, wherein the second optical element is in the optical path between the first optical element and the field plane.

20. An optical system according to claim 19, wherein a pupil raster element is assigned to each field raster element and wherein a light ray is formed between the field raster element and its assigned pupil raster element in such a way that an exit pupil illumination in an exit pupil plane of the illumination system has a telecentricity error of ≦2.5 mrad.

21. A system, comprising:
the optical system of claim 1; and
a projection objective,
wherein the system is a projection exposure apparatus configured so that an object illuminated in the field plane by the illumination system is projected into an image plane of the projection objective.

22. A method, comprising:
providing an optical system comprising an optical element comprising field raster elements, the optical system being configured so that during use the optical system directs light along an optical path to illuminate a field plane and an exit pupil plane, the optical element being in a second plane along the optical path upstream of the field plane;
using an illumination-adjusting device to adjust an illumination in the second plane so that the uniformity of the field illumination of the field has a uniformity error ≦10;
assigning to each of the field raster elements a pupil raster element of a second optical element, whereby a light channel is defined, the assignment being made so that the illumination of the exit pupil plane has a telecentricity error of ≦2 mrad, and/or an ellipticity of 1±0.1.

23. A method according to claim 22, wherein the illumination-adjusting device comprises aperture stops which are assigned to the incompletely illuminated field raster elements, the illuminated field has a scanning direction in the plane, and for the adjustment of the uniformity the aperture stops are moved in a direction perpendicular to the scanning direction.

24. A method according to claim 22, wherein the illumination-adjusting device comprises a device configured to deform and/or tilt the optical element, and the optical element is deformed and/or tilted adjust the uniformity.

25. A method according to claim 22, wherein the field raster elements are arranged with a tilt angle on a carrier, and the tilt angle can be varied via actuators so that the assignment of field raster elements to pupil raster elements is adjusted.

26. A method, comprising:
using the projection exposure apparatus of claim 21 to manufacture microelectronic components.
